(19) United States
(12) Patent Application Publication
(10) Pub. No.: US 2025/0178363 A1
(43) Pub. Date: Jun. 5, 2025

(54) PRINTING APPARATUS, CONTROL METHOD, AND STORAGE MEDIUM

(71) Applicant: CANON KABUSHIKI KAISHA, Tokyo (JP)

(72) Inventor: MASAKI SUZUKI, Kanagawa (JP)

(21) Appl. No.: 18/960,293

(22) Filed: Nov. 26, 2024

(30) Foreign Application Priority Data
Dec. 4, 2023 (JP) 2023-204912

(51) Int. Cl. B41J 11/00; B41J 2/325; B41J 25/304

(52) U.S. Cl. CPC B41J 11/008; B41J 2/325; B41J 11/0095; B41J 25/304

(57) ABSTRACT

A printing apparatus detects a position of a recording sheet being conveyed, and controls transferring of ink and conveying of the recording sheet. The apparatus determines a transfer start position of the ink based on a detected position of a following end of the recording sheet being conveyed before the transferring of the ink starts, and determines a transfer end position of the ink based on a detected position of the following end of the recording sheet being conveyed in a second state where a space through which the recording sheet being conveyed can pass is narrower than a predetermined first state.

### BACKGROUND OF THE INVENTION

### Field of the Invention

The present invention relates to a printing apparatus, a control method, and a storage medium.

### Description of the Related Art

Printing apparatuses that print by transferring ink onto a sheet using a thermal transfer recording method have become known in recent years. In such a printing apparatus, it may be desirable to print onto sheet-type paper held in a paper tray such that there is no blank margin. In response to such demand, Japanese Patent Laid-Open No. 2002-274061 discloses a technique in which a perforation is provided at two ends of a sheet of paper, and the paper is cut along the perforation after printing to produce a printed product having no blank margin.

However, with the technique disclosed in Japanese Patent Laid-Open No. 2002-274061, it is necessary to cut the paper along the perforation at two locations, which requires effort after the printing. It is also necessary to provide blank margins to cut at two locations, which increases costs associated with paper. What is needed, therefore, is a technique for appropriately controlling transfer in the vicinity of at least one end of a sheet so as to reduce the number of locations requiring cutting and ensure that there is no blank margin at the end of the sheet.

### SUMMARY OF THE INVENTION

The present invention provides a technique that makes it possible to appropriately control transfer in the vicinity of an end of a sheet.

In order to solve the aforementioned issues, one aspect of the present disclosure provides a printing apparatus comprising: a detection unit configured to detect a position of a recording sheet being conveyed; and a control unit configured to control transferring of ink and conveying of the recording sheet, wherein the control unit: determines a transfer start position of the ink based on a position, detected by the detection unit, of a following end of the recording sheet being conveyed before the transferring of the ink starts, and determines a transfer end position of the ink based on a position, detected by the detection unit, of the following end of the recording sheet being conveyed in a second state where a space through which the recording sheet being conveyed can pass is narrower than a predetermined first state.

Another aspect of the present disclosure provides a control method of a printing apparatus including a detection unit configured to detect a position of a recording sheet being conveyed, the control method comprising: controlling transferring of ink and conveying of the recording sheet, wherein the controlling includes: determining a transfer start position of the ink based on a position, detected by the detection unit, of a following end of the recording sheet being conveyed before the transferring of the ink starts, and determining a transfer end position of the ink based on a position, detected by the detection unit, of the following end of the recording sheet being conveyed in a second state where a space through which the recording sheet being conveyed can pass is narrower than a predetermined first state.

Still another aspect of the present disclosure provides a non-transitory computer-readable storage medium storing a program for causing a computer to execute a control method of a printing apparatus including a detection unit configured to detect a position of a recording sheet being conveyed, the control method comprising: controlling transferring of ink and conveying of the recording sheet, wherein the controlling includes: determining a transfer start position of the ink based on a position, detected by the detection unit, of a following end of the recording sheet being conveyed before the transferring of the ink starts, and determining a transfer end position of the ink based on a position, detected by the detection unit, of the following end of the recording sheet being conveyed in a second state where a space through which the recording sheet being conveyed can pass is narrower than a predetermined first state.

According to the present invention, it is possible to appropriately control transfer in the vicinity of an end of a sheet.

Further features of the present invention will become apparent from the following description of exemplary embodiments (with reference to the attached drawings).

### BRIEF DESCRIPTION OF THE DRAWINGS

FIGS. 1A and 1B are perspective views illustrating an example of the external configuration of a printer serving as an example of a printing apparatus according to an embodiment.

FIGS. 2A and 2B are perspective views of an ink ribbon cassette according to the embodiment.

FIG. 3 is an exploded perspective view of the ink ribbon cassette according to the embodiment.

FIG. 4 is an unfolded diagram illustrating the ink ribbon according to the embodiment.

FIGS. 5A to 5C are cross-sectional views illustrating printing operations by the printer according to the embodiment.

FIGS. 6A to 6C are cross-sectional views illustrating printing operations by the printer according to the embodiment.

FIGS. 7A to 7C are cross-sectional views illustrating printing operations by the printer according to the embodiment.

FIG. 8 is a cross-sectional view illustrating printing operations by the printer according to the embodiment.

FIGS. 9A and 9B are flowcharts illustrating a series of operations in the printing operations by the printer according to the embodiment.

FIGS. 10A and 10B are diagrams illustrating processing for calculating a transfer start position according to the embodiment.

FIG. 11 is a diagram schematically illustrating a region heated by a heating element of a thermal head according to the embodiment.

FIG. 12 is a diagram schematically illustrating the effect of bending in a sheet.

FIG. 13 is a diagram schematically illustrating an issue can may arise when printing without a blank margin.

FIG. 14 is a diagram illustrating a state in which a following end of a sheet is detected during printing operations according to the embodiment.

FIG. 15 is a block diagram illustrating an example of the functional configuration of the printer according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

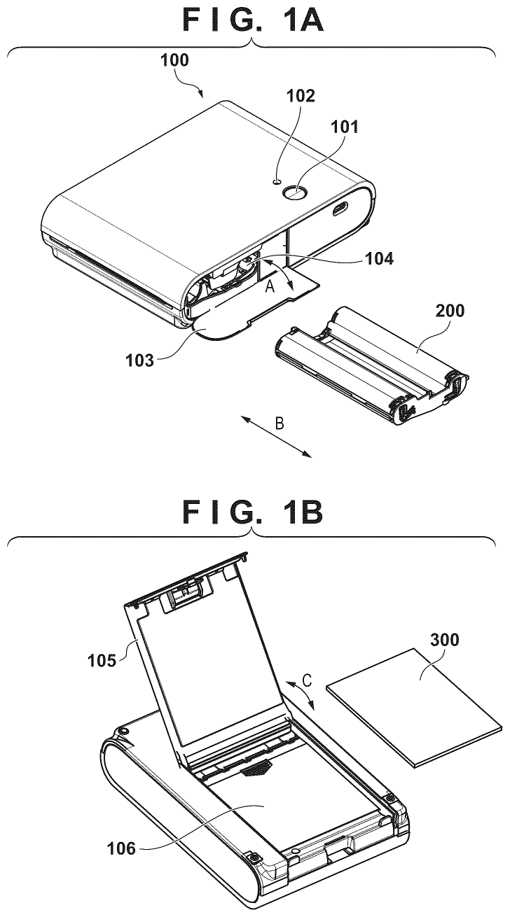

A printer that uses a thermal transfer recording method will be described hereinafter as an example of a printing apparatus according to the present embodiment. An example of the external configuration of a printer 100 will be described with reference to FIGS. 1A and 1B. FIG. 1A is a perspective view taken from the top side, and FIG. 1B is a perspective view taken from the bottom side. 100 indicates the printer, and 200 indicates an ink ribbon cassette. As illustrated in FIG. 1A, a power button 101 and a display unit 102 are disposed in a top surface of the printer 100, and the power of the printer 100 can be turned on by operating the power button 101. The display unit 102 can flash and light up, and the display unit 102 lights up when the power of the printer 100 is on. 103 indicates a cover, which is disposed on a side surface of the printer 100 and is configured to be capable of opening and closing in the directions indicated by the arrow A. When the cover 103 is open, the ink ribbon cassette 200 can be inserted into and removed from an ink ribbon cassette insertion port 104, in the directions indicated by the arrow B. As illustrated in FIG. 1B, a sheet cover 105, which is axially supported to be capable of opening and closing in the directions indicated by the arrow C, is provided on the bottom surface of the printer 100. A sheet loading unit 106 is provided within the area exposed when the sheet cover 105 is opened. With the sheet cover 105 open, a user can load sheets 300, which are cut to a predetermined length, into the sheet loading unit 106. The sheet 300 loaded into the sheet loading unit 106 is pulled out one sheet at a time into the interior of the printer 100 by a sheet feeding mechanism provided in the printer 100.

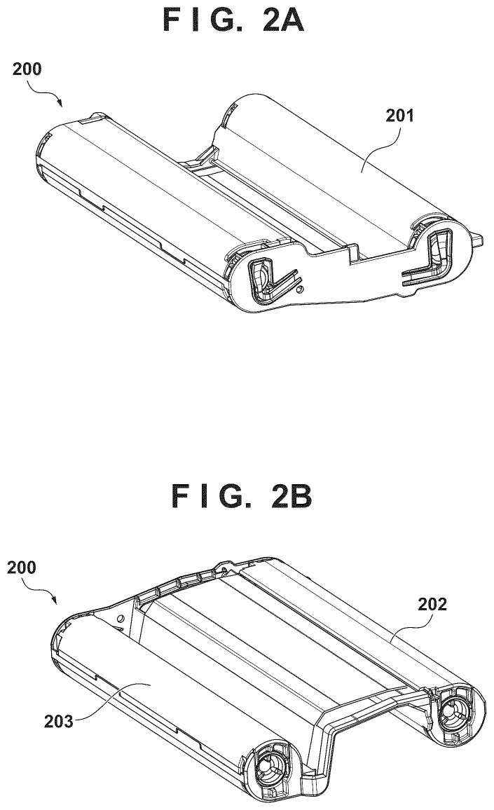

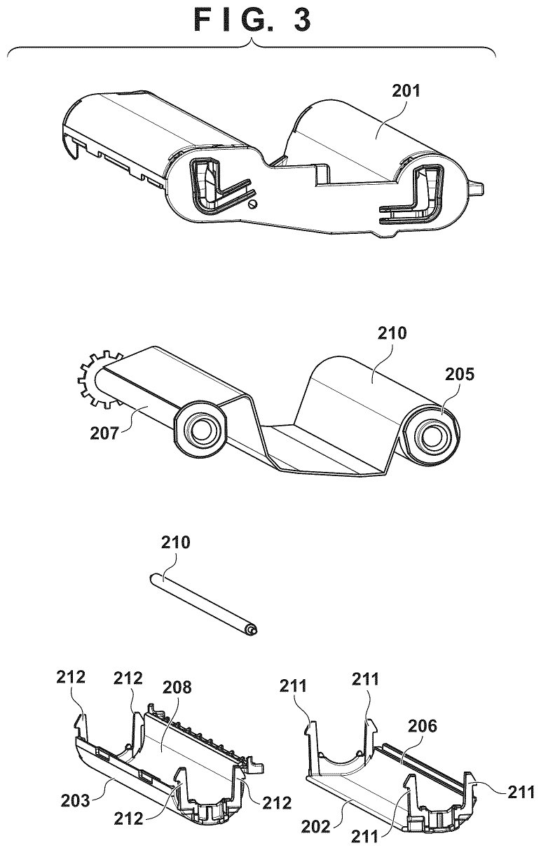

The external configuration of the ink ribbon cassette 200 according to the present embodiment will be described next with reference to FIGS. 2A and 2B. FIG. 2A is a perspective view of the ink ribbon cassette 200 seen from the top surface, and FIG. 2B is a perspective view of the ink ribbon cassette 200 seen from the bottom surface. FIG. 3, meanwhile, is an exploded perspective view of the ink ribbon cassette 200 according to the present embodiment.

A housing part of the ink ribbon cassette 200 is constituted by an upper case 201, a first lower case 202, and a second lower case 203, as illustrated in FIGS. 2A, 2B, and 3. The upper case 201, the first lower case 202, and the second lower case 203 are formed from a resin, for example.

205 indicates a feed bobbin, 207 indicates a winding bobbin, and 210 indicates an ink ribbon. The ink ribbon 210 is configured such that the cylindrical feed bobbin 205 and winding bobbin 207, around which the ink ribbon is wound, are contained within the ink ribbon cassette 200, for ease of insertion to and removal from the printer 100. The feed bobbin 205 and the winding bobbin 207 are formed from a resin, for example, so as to have the same shape, and the ink ribbon 210 is wound around the feed bobbin 205. As illustrated in FIG. 3, the first lower case 202 includes a feed bobbin storage part 206 that contains the feed bobbin 205. The first lower case 202 has a pair of engagement claws 211 on both end parts, for engaging with the upper case 201. The second lower case 203 includes a winding bobbin storage part 208 that contains the winding bobbin 207. The second lower case 203 has a pair of engagement claws 212 on both end parts, for engaging with the upper case 201.

The feed bobbin 205 is rotatably held by the upper case 201 and the first lower case 202, and the winding bobbin 207 is rotatably held by the upper case 201 and the second lower case 203. The ink ribbon 210 wound around the feed bobbin 205 can be taken up onto the winding bobbin 207 by rotationally driving the winding bobbin 207.

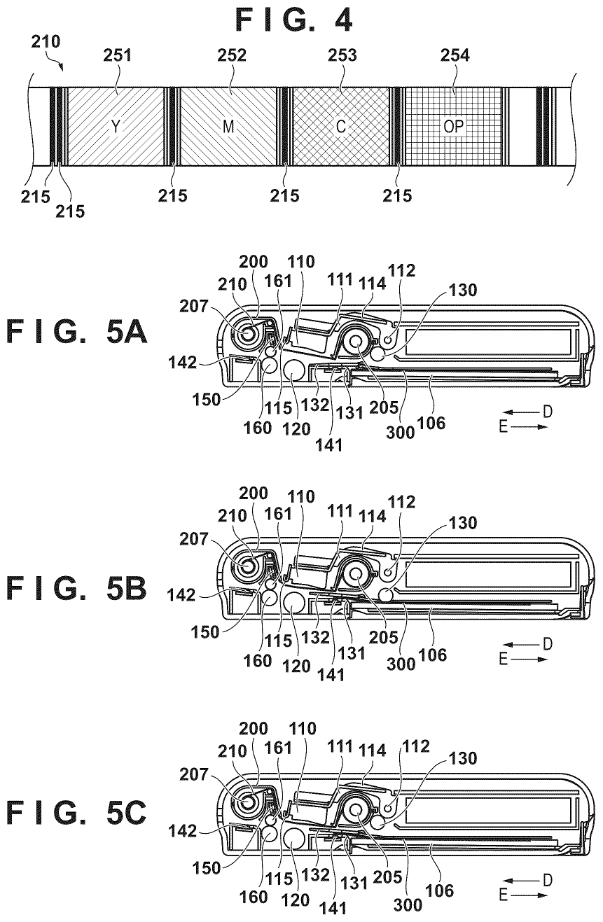

The configuration of the ink ribbon 210 will be described in further detail with reference to FIG. 4. FIG. 4 is an unfolded diagram illustrating the ink ribbon 210 according to the present embodiment. Yellow dye 251, magenta dye 252, cyan dye 253, and an overcoat layer 254 are applied to the ink ribbon 210 in that order, and band-shaped markers 215 are applied at cueing positions for each of those surfaces. Each marker 215 is a black line, and an ink ribbon sensor (described later) can detect when emitted light is being blocked by the marker 215. Two markers 215 are provided at the beginning part of the yellow dye 251, which distinguishes those markers from the single markers provided at the beginning parts of the other colors. This distinction makes it possible to recognize the cueing position of the yellow dye 251.

### Example of Printer Configuration Related to Printing Operations

Printing operations performed by the printer 100 according to the present embodiment will be described next. First, an example of the configuration of the printer 100 related to the printing operations of the present embodiment will be described with reference to FIGS. 5A to 5C. Note that FIG. 5A is a cross-sectional view illustrating a standby state, FIG. 5B is a cross-sectional view illustrating sheet feeding operations, and FIG. 5C is a cross-sectional view illustrating cueing operations for the ink ribbon 210.

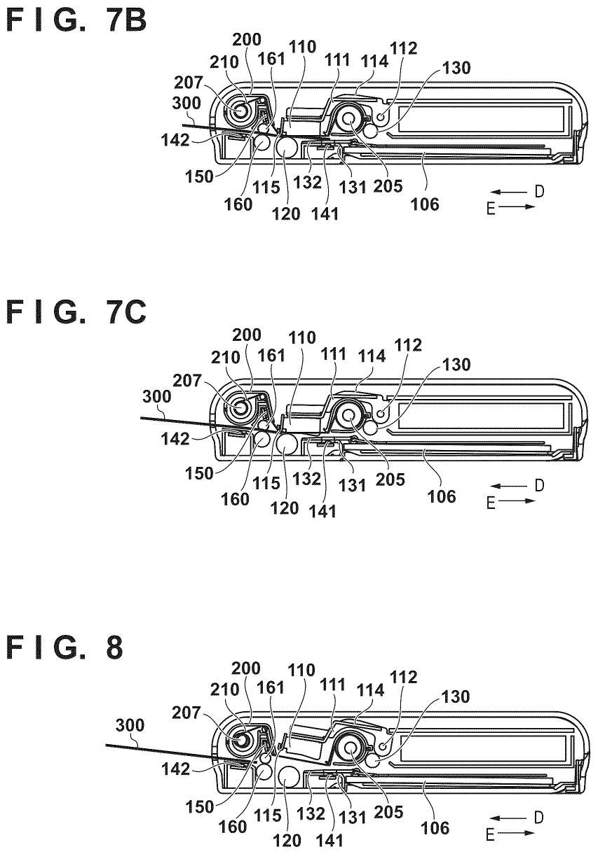

As illustrated in FIG. 5A, a head arm 111 is supported so as to be rotatable about a head support shaft 112. A thermal head 110 is supported by the head arm 111, and is capable of rotating from a standby position, illustrated in FIG. 5A, to a printing position where a compressive force is produced against a platen roller 120 (described later with reference to FIG. 7A). The sheet 300 and the ink ribbon 210 are pressed against each other by the thermal head 110 and the platen roller 120. The thermal head 110 is electrified, causing a heating element of the thermal head 110 to produce heat, which sublimates the dye applied to the ink ribbon 210 and transfers the dye to the sheet. When printing in full color, the three colors of yellow (Y), magenta (M), and cyan (C), which are applied to the ink ribbon 210 in that order, are transferred so as to overlap with each other in that order.

As illustrated in FIG. 5A, in the standby state, the thermal head 110 is biased about the head support shaft 112 by a head biasing spring (not shown) in what is the clockwise direction in the figure. The thermal head 110 is restricted to the standby position, where the distance from the platen roller 120 is maximum, so as not to interfere with the ink ribbon cassette 200 during insertion and removal.

A heatsink 114 is attached to the thermal head 110, and the configuration is such that heat produced by the thermal head 110 can transfer to the heatsink 114. The platen roller 120 is rotatably disposed in the printer 100, and is configured to rotate in accordance with the conveyance of the sheet 300. A peeling plate 115 is attached to the thermal head 110. The direction of the ink ribbon 210 is shifted by approximately 90° by the peeling plate 115, and is peeled from the sheet 300 as a result.

130 indicates a sheet feeding roller. The sheet feeding roller 130 can be rotationally driven by being driven by a sheet feeding drive motor (not shown). The sheet feeding roller 130 is also capable of moving from a retracted position at which the roller is distanced from the sheet 300, illustrated in FIG. 5A, to a sheet feeding position at which the roller makes contact with the sheet 300, illustrated in FIG. 5B.

131 indicates a separation plate, and 132 indicates a sheet guide. The sheet guide 132 is lifted by the sheet 300 during feeding, and is supported so as to be rotatable from the position indicated in FIG. 5A to the position indicated in FIG. 5B. The sheet guide 132 is constantly biased in a downward direction, and is in a position of contact with the separation plate 131 illustrated in FIG. 5A.

141 indicates a sheet feed port sensor, 142 indicates a sheet discharge port sensor, and 150 indicates an ink ribbon sensor. The sheet feed port sensor 141 and the sheet discharge port sensor 142 can detect the presence or absence of the sheet 300 by detecting reflected light produced when emitted light is reflected by a back surface of the sheet 300. The ink ribbon sensor 150 detects light which has been emitted and reflected by a wall surface of the ink ribbon cassette 200, and can detect the position of the marker 215 when the emitted light is blocked by the marker 215.

160 indicates a conveyance roller, and 161 indicates a driven roller. The conveyance roller 160 is rotationally driven by a sheet conveyance motor (not shown). The driven roller 161 is a driven roller opposite the conveyance roller 160, and is configured to rotate in accordance with the rotation of the conveyance roller 160.

### Function Blocks Related to Printing Operations

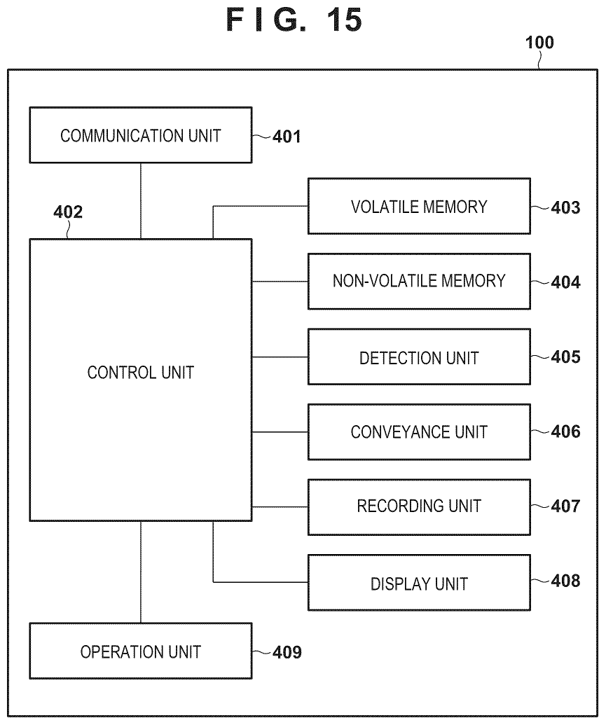

An example of function blocks related to the printing operations of the present embodiment will be described next with reference to FIG. 15. Note that the configurations of the printer 100 included in the respective blocks are not limited to the following descriptions, and the respective configurations described in the present embodiment may be included in one or more of the function blocks. A communication unit 401 includes communication circuitry for communicating with an external device, such as a smartphone or the like, over wires or wirelessly. A control unit 402 includes, for example, one or more processors, and controls various parts of the printer 100 to realize various types of operations of the printer 100, such as printing operations, by loading computer programs stored in a non-volatile memory 404 into a volatile memory 403 and executing the programs.

The volatile memory 403 includes a volatile storage medium such as a DRAM, and temporarily stores data such as execution results from the control unit 402, print data supplied from the external device, and the like. The non-volatile memory 404 includes a non-volatile storage medium, and can store various types of computer programs such as an operating system, applications, and the like in addition to computer programs related to printing operations.

A detection unit 405 includes various types of sensors, such as the sheet feed port sensor 141, the sheet discharge port sensor 142, and the ink ribbon sensor 150. The control unit 402 can determine whether an end of a sheet has been detected in accordance with a detection result from the detection unit 405.

A conveyance unit 406 includes components such as rollers and a drive source (e.g., a drive motor) for performing feeding, conveying, and discharging sheets. For example, the conveyance unit 406 includes the sheet feeding roller 130, the sheet feeding drive motor that rotates the sheet feeding roller 130, and a drive source that moves the sheet feeding roller 130. The drive source that moves the sheet feeding roller 130 may be a motor, for example. The conveyance unit 406 also includes the conveyance roller 160, the driven roller 161, and a drive source that rotates the conveyance roller 160. The drive source that rotates the conveyance roller 160 may be a motor, for example. The control unit 402 can control sheet feeding, conveyance, and the like in the printer 100 by controlling the drive motor and the drive source for sheet feeding, conveyance, and the like.

A recording unit 407 may include the thermal head 110 that transfers the dyes to the sheet. A head drive motor that moves the position of the thermal head 110 may be included in the recording unit 407, or may be provided separate from the recording unit 407. The control unit 402 can, for example, control transfers onto sheets by the recording unit 407, the movement of the recording unit 407, and the like.

A display unit 408 includes a display member that flashes and lights up, such as an LED or the like, for example. For example, the display unit 408 includes the display unit 102. The control unit 402 can control displays made in the display unit 408, for example. An operation unit 409 includes operation members such as the power button 101. The control unit 402 can control the operations of the printer 100 in accordance with user operations made in the operation unit 409.

### Series of Operations Involved in Printing Operations

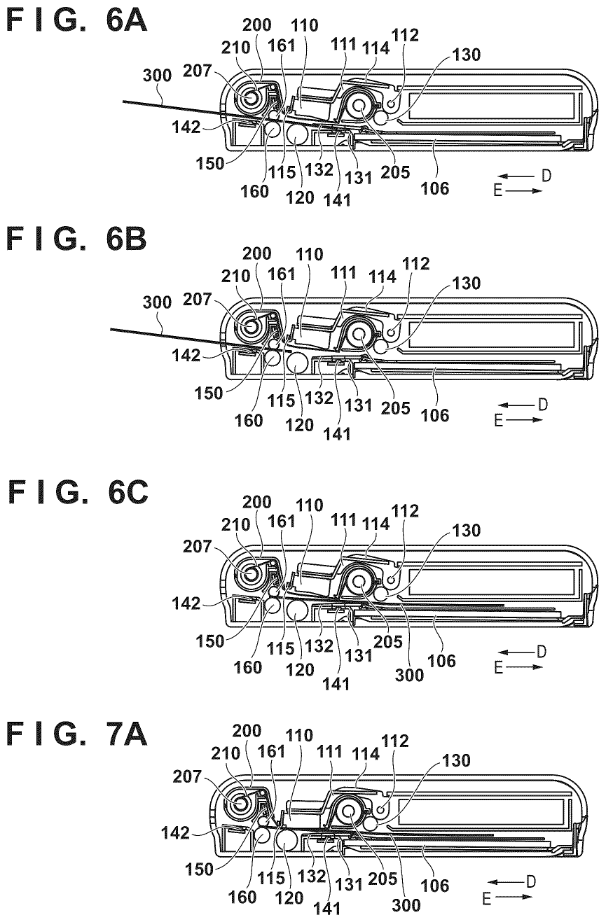

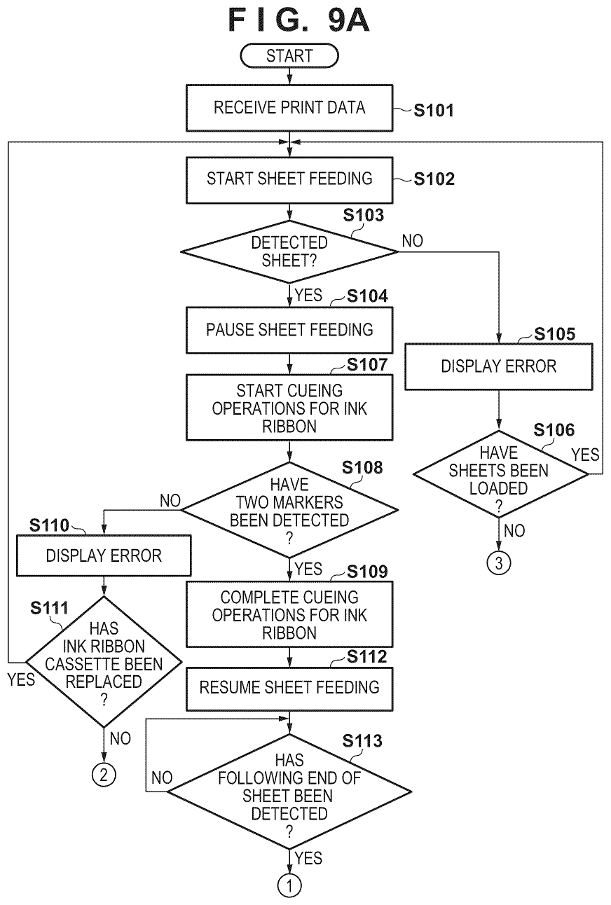

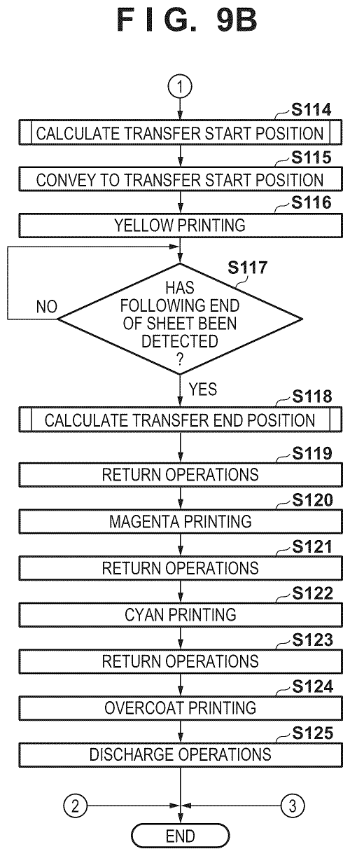

A series of operations performed during printing operations, illustrated in FIGS. 9A and 9B, will be described next with reference to FIGS. 5A to 8 as appropriate. FIG. 6A is a cross-sectional view illustrating the detection of a following end of a sheet, FIG. 6B is a cross-sectional view illustrating a state after sheet feeding is resumed, and FIG. 6C is a cross-sectional view illustrating a state at the time of printing. FIG. 7A is a cross-sectional view illustrating a state during printing, FIG. 7B is a cross-sectional view illustrating the detection of the following end of the sheet, FIG. 7C is a cross-sectional view illustrating a state when printing ends, and FIG. 8 is a cross-sectional view illustrating a state after a sheet is discharged.

Note that the printing operations according to the present embodiment are implemented by the control unit 402 loading a computer program stored in the non-volatile memory 404 into the volatile memory 403, executing the program, and controlling the constituent elements of the printer 100. Additionally, the operations of the printer 100 illustrated in FIGS. 9A and 9B are started when the user loads the ink ribbon cassette 200 and the sheets 300 into the printer 100 and presses the power button 101, which puts the printer 100 in the standby state.

In step S101, when print data is supplied from a mobile terminal such as a smartphone (not shown) through the communication unit 401, the control unit 402 receives the print data. At this time, the control unit 402 causes the display unit 102 to start a flashing display, which indicates a data loading state, and then changes the display from the flashing state to a lighted display once the reception of the print data is complete.

In step S102, the control unit 402 controls the position of the thermal head 110 by controlling the drive motor for the thermal head 110, and furthermore starts feeding a sheet by controlling the sheet feeding drive motor. The thermal head 110 is rotated by the head drive motor about the head support shaft 112 in what is the counterclockwise direction in the drawings, and moves from the standby position illustrated in FIG. 5A to an intermediate position illustrated in FIG. 5B. The sheet feeding roller 130 is pushed downward from the retracted position illustrated in FIG. 5A to the sheet feeding position illustrated in FIG. 5B, makes contact with the sheet 300, is rotated by the sheet feeding drive motor in what is the clockwise direction in the drawings, and conveys the sheet 300 loaded in the sheet loading unit 106 toward the interior of the printer 100. The sheet 300 contacts the separation plate 131 provided in the printer 100, and a leading end of the sheet 300 furthermore pushes the sheet guide 132 upward, such that only the single uppermost sheet 300 is conveyed.

In step S103, the control unit 402 determines whether the sheet 300 has been detected by the sheet feed port sensor 141. The control unit 402 moves the sequence to step S104 if the sheet 300 has been detected, and to step S105 if not (e.g., if no sheet 300 is detected within a prescribed period of time). If no sheet 300 is detected, the control unit 402 can determine that no sheets 300 are loaded in the sheet loading unit 106.

In step S104, the control unit 402 stops the rotation of the sheet feeding roller 130, and pauses the sheet feeding operations. The sheet feeding roller 130 is pushed upward by the drive source (not shown), from the sheet feeding position illustrated in FIG. 5B to the retracted position illustrated in FIG. 5C. Because the sheet guide 132 is constantly biased in the downward direction, the sheet 300 is stably held between the separation plate 131 and the sheet guide 132 at the position illustrated in FIG. 5C.

On the other hand, in step S105, the control unit 402 displays an error indication indicating that the sheet 300 could not be fed by causing the display unit 102 to perform the lighted display and sending the error indication to the mobile terminal (not shown) via the communication unit 401. Doing so makes it possible to prompt the user to load the sheets 300 into the sheet loading unit 106 of the printer 100. At this time, the control unit 402 stops the rotation of the sheet feeding roller 130. The sheet feeding roller 130 is also pushed upward by the drive source (not shown), from the sheet feeding position illustrated in FIG. 5B to the retracted position illustrated in FIG. 5A. The thermal head 110 is then rotated by the head drive motor about the head support shaft 112 in what is the counterclockwise direction in the drawings, and moves from the intermediate position illustrated in FIG. 5B to the standby position illustrated in FIG. 5A.

In step S106, the control unit 402 determines whether the sheets 300 have been loaded by the user (e.g., using the sheet feed port sensor 141). Once the sheets 300 have been loaded, the sequence advances to step S102, but if sheets 300 have not been loaded, the printing is stopped and the series of operations ends.

In step S107, the control unit 402 starts the cueing operations for the yellow dye 251 of the ink ribbon 210. A leading end of the winding bobbin 207 disposed within the ink ribbon cassette 200 engages with an engagement part provided in the printer 100, and the winding bobbin 207 rotates in what is the counterclockwise direction in the drawings under a force (not shown) according to an instruction from the control unit 402. As a result, the ink ribbon 210 wound around the feed bobbin 205 is taken up onto the winding bobbin 207. As illustrated in FIG. 4, the markers 215 are provided at the beginning of each color of ink on the ink ribbon 210, and two of the markers 215 are provided at the start of the yellow dye 251 in particular. The printer 100 has the ink ribbon sensor 150, which is a reflective photosensor, and detects reflected light being blocked by the markers 215 provided on the ink ribbon 210. The control unit 402 cues the yellow dye 251 by the ink ribbon sensor 150 continuously detecting the two markers 215 within a prescribed period of time.

In step S108, the control unit 402 determines whether the two markers 215 at the beginning of the yellow dye 251 have been detected by the ink ribbon sensor 150. When the two markers 215 are detected, the control unit 402 moves the sequence to step S109. However, if the two markers 215 cannot be detected, the control unit 402 moves the sequence to step S110. If the two markers 215 are not detected, the control unit 402 can determine that there is no ink ribbon 210 remaining in the ink ribbon cassette 200 loaded in the printer 100. In step S109, the control unit 402 completes the cueing operations for the yellow dye 251.

In step S110, the control unit 402 first pushes the sheet feeding roller 130 downward, from the retracted position illustrated in FIG. 5C to the sheet feeding position illustrated in FIG. 5B, using the drive source, bringing the roller into contact with the sheet 300. In this state, the control unit 402 rotates the sheet feeding roller 130 in what is the counterclockwise direction in the drawings using the sheet feeding drive motor, which conveys the sheet 300 toward the sheet loading unit 106. Once the sheet 300 has completely returned to the sheet loading unit 106, the control unit 402 controls the head drive motor to rotate the thermal head 110 about the head support shaft 112 in what is the counterclockwise direction in the drawings, and move from the intermediate position illustrated in FIG. 5B to the standby position illustrated in FIG. 5A. The control unit 402 causes the display unit 102 to light up, and displays an error indication indicating that there is no ink ribbon 210 remaining in the ink ribbon cassette 200 in the mobile terminal or the like, via the communication unit 401. Doing so makes it possible to prompt the user to replace the ink ribbon cassette 200.

In step S111, the control unit 402 determines whether the ink ribbon cassette 200 has been replaced by the user. The control unit 402 moves the sequence to step S102 if the ink ribbon cassette 200 is determined to have been replaced, but stops the printing, and ends the series of operations, if not (if the ink ribbon cassette 200 is not replaced).

In step S112, the control unit 402 resumes the sheet feeding. The control unit 402 pushes the sheet feeding roller 130 downward, from the retracted position illustrated in FIG. 5C to the sheet feeding position illustrated in FIG. 5B, using the drive source, bringing the roller into contact with the sheet 300. In this state, the control unit 402 rotates the sheet feeding roller 130 in what is the clockwise direction in the drawings using the sheet feeding drive motor, which resumes the sheet feeding operations. The sheet 300 is conveyed in the direction of the arrow D by the sheet feeding roller 130. At this time, the conveyance roller 160 is rotating in accordance with the rotational speed of the sheet feeding roller 130 in what is the counterclockwise direction in the drawings using the drive source for the conveyance roller. The sheet 300 therefore enters into a nip position between the conveyance roller 160 and the driven roller 161 without any load placed thereon, and is further conveyed in the direction of the arrow D. When the sheet 300 is nipped between the conveyance roller 160 and the driven roller 161 and conveyed in the direction of the arrow D, the sheet feeding roller 130 stops rotating and is pushed upward by the drive source to the retracted position illustrated in FIG. 6A. The sheet 300 is conveyed by the conveyance roller 160 to the position illustrated in FIG. 6A.

In step S113, the control unit 402 determines whether a following end 302 of the sheet 300 has been detected by the sheet feed port sensor 141. The control unit 402 moves the sequence to step S114 if the following end 302 is determined to have been detected, and repeats the processing from step S113 if not.

In step S114, the control unit 402 calculates a transfer start position from the result of detecting the position of the following end 302 of the sheet in step S113. This will be described in detail later.

In step S115, the control unit 402 conveys the sheet 300 using the conveyance roller 160. When the sheet 300 is conveyed by the conveyance roller 160 to the position illustrated in FIG. 6B, the sheet guide 132 is pushed down from the position illustrated in FIG. 6A to the position illustrated in FIG. 6B. Then, after stopping the rotation, the conveyance roller 160 is rotated in what is the clockwise direction in the drawings by the drive source, and the sheet 300 is conveyed in the direction of the arrow E. Because the sheet guide 132 is pushed down to the position illustrated in FIG. 6B, the sheet 300 is conveyed toward a conveyance path above the sheet loading unit 106. The sheet 300 is conveyed to the transfer start position illustrated in FIG. 6C, calculated in step S114, which completes the sheet feeding operations.

In step S116, the control unit 402 performs yellow printing (i.e., transferring the yellow dye 251). The control unit 402 rotates the head arm 111 using the head drive motor, which causes the thermal head 110 to remain at a printing position, illustrated in FIG. 7A. The sheet 300 and the ink ribbon 210 are pressed against each other by the thermal head 110 and the platen roller 120. Then, while the sheet 300 is being conveyed in the direction of the arrow D by the conveyance roller 160, the control unit 402 causes a heating element 110-A of the thermal head 110 to generate heat according to a printing signal, which thermally transfers the yellow dye 251 on the ink ribbon 210 to the sheet 300. The winding bobbin 207 is rotationally driven by the drive source (not shown), and the ink ribbon 210 during the printing operations is conveyed in the direction of the arrow D at the same conveyance speed as the sheet 300.

When the sheet 300 is conveyed to the position indicated in FIG. 7B during yellow printing, in step S117, the control unit 402 determines whether the following end 302 of the sheet 300 has been detected by the sheet feed port sensor 141. The control unit 402 moves the sequence to step S118 if the following end 302 has been detected, and returns the sequence to step S117 if not.

In step S118, the control unit 402 calculates a transfer end position from the result of detecting the position of the following end 302 of the sheet in step S117. This will be described in detail later. As illustrated in FIG. 7C, when the sheet 300 is conveyed to the transfer end position calculated in step S118, the heating of the heating element 110-A of the thermal head 110 is stopped, and the yellow printing ends. At this time, to print such that no blank margin is present at the following end 302 of the sheet 300, the following end 302 stops at a position to which it is further conveyed in the direction of the arrow D than the position at which the sheet 300 is pressed between the thermal head 110 and the platen roller 120.

Next, in step S119, the control unit 402 performs return operations in order to perform magenta printing (i.e., transferring the magenta dye 252). First, the control unit 402 rotates the head arm 111 to release the sheet 300 from between the thermal head 110 and the platen roller 120, stopping at the intermediate position illustrated in FIG. 6B. Then, using the conveyance roller 160, the control unit 402 conveys the sheet 300 in the direction of the arrow E to the printing position illustrated in FIG. 6C. The winding bobbin 207 is also rotated at the same time. When the ink ribbon sensor 150 detects the marker 215 provided at the beginning of the magenta dye 252, the rotation of the winding bobbin 207 is stopped, and the cueing of the magenta dye 252 is complete.

In step S120, the control unit 402 performs magenta printing. As with the yellow printing described above, the control unit 402 rotates the head arm 111 using the head drive motor, stops the thermal head 110 at the position illustrated in FIG. 7A, and presses the sheet 300 against the ink ribbon 210 using the thermal head 110 and the platen roller 120. Then, while the sheet 300 is being conveyed in the direction of the arrow D by the conveyance roller 160, the control unit 402 causes a heating element 110-A of the thermal head 110 to generate heat according to a printing signal, which thermally transfers the magenta dye 252 on the ink ribbon 210 to the sheet 300. As with the yellow printing, when the sheet 300 is conveyed to the transfer end position calculated in step S118 and illustrated in FIG. 7C, the heating of the heating element 110-A of the thermal head 110 is stopped, and the magenta printing ends. At this time, to print such that no blank margin is present at the following end 302 of the sheet 300, the following end 302 stops at a position to which it is further conveyed in the direction of the arrow D than the position at which the sheet 300 is pressed between the thermal head 110 and the platen roller 120.

In step S121, the control unit 402 performs return operations in the same manner as in step S119. First, the head arm 111 is rotated to release the sheet 300 from between the thermal head 110 and the platen roller 120, stopping at the intermediate position illustrated in FIG. 6B. Then, the sheet 300 is conveyed by the conveyance roller 160 in the direction of the arrow E to the printing position illustrated in FIG. 6C. The control unit 402 also rotates the winding bobbin 207 at the same time. Then, when the ink ribbon sensor 150 detects the marker 215 provided at the beginning of the cyan dye 253, the control unit 402 stops the rotation of the winding bobbin 207, and cues the cyan dye 253.

In step S122, the control unit 402 performs cyan printing (i.e., transferring the cyan dye 253). The control unit 402 rotates the head arm 111 using the head drive motor, stops the thermal head 110 at the position illustrated in FIG. 7A, and presses the sheet 300 against the ink ribbon 210 using the thermal head 110 and the platen roller 120. Then, while the sheet 300 is being conveyed in the direction of the arrow D by the conveyance roller 160, the control unit 402 causes the heating element 110-A of the thermal head 110 to generate heat according to the provided printing signal, which thermally transfers the cyan dye 253 on the ink ribbon 210 to the sheet 300 and prints the cyan color. As with the yellow printing, when the sheet 300 is conveyed to the transfer end position calculated in step S118 and illustrated in FIG. 7C, the heating of the heating element 110-A of the thermal head 110 is stopped, and the cyan printing ends. At this time, to print such that no blank margin is present at the following end 302 of the sheet 300, the following end 302 stops at a position to which it is further conveyed in the direction of the arrow D than the position at which the sheet 300 is pressed between the thermal head 110 and the platen roller 120.

The printer 100 of the present embodiment performs overcoat printing in order to reduce situations where external factors cause deterioration of the image printed on the sheet 300 after printing the three colors. The control unit 402 again moves the sequence to the return operations in order to perform the overcoat printing.

In step S123, the control unit 402 performs return operations in the same manner as in step S119. First, the head arm 111 is rotated to release the sheet 300 from between the thermal head 110 and the platen roller 120, stopping at the intermediate position illustrated in FIG. 6B. Then, the sheet 300 is conveyed by the conveyance roller 160 in the direction of the arrow E to the printing position illustrated in FIG. 6C.

The winding bobbin 207 is also rotated at the same time. Then, when the ink ribbon sensor 150 detects the marker 215 provided at the beginning of the overcoat layer 254, the rotation of the winding bobbin 207 is stopped, and the overcoat layer 254 is cued.

In step S124, the control unit 402 performs overcoat printing. As with the yellow printing described above, in the overcoat printing, the head arm 111 is rotated using the drive source (not shown), the thermal head 110 is stopped at the position illustrated in FIG. 7A, and the sheet 300 is pressed against the ink ribbon 210 using the thermal head 110 and the platen roller 120. Then, while the sheet 300 is being conveyed in the direction of the arrow D by the conveyance roller 160, the control unit 402 causes the heating element 110-A of the thermal head 110 to generate heat according to the printing signal. The overcoat layer 254 on the ink ribbon 210 is thermally transferred to the sheet 300, and overcoat printing is performed.

In step S125, the control unit 402 performs sheet discharge operations. Once the overcoat printing ends, to discharge the sheet 300 from the printer 100, the control unit 402 rotationally drives the conveyance roller 160 in what is the counterclockwise direction in the drawings, and the sheet 300 is conveyed to a position distanced from the nip between the conveyance roller 160 and the driven roller 161, illustrated in FIG. 8. The head arm 111 is rotated by the drive source (not shown), and the thermal head 110 moves to the standby position illustrated in FIG. 8. At this time, the sheet 300 is detected by the sheet discharge port sensor 142. Accordingly, the printer 100 lights the display unit 102, and further makes a notification to the mobile terminal (not shown) that the printed sheet 300 is to be removed (step S125). Then, when the user removes the printed sheet 300, the sheet discharge port sensor 142 detects that the sheet 300 has been removed, and the printing ends.

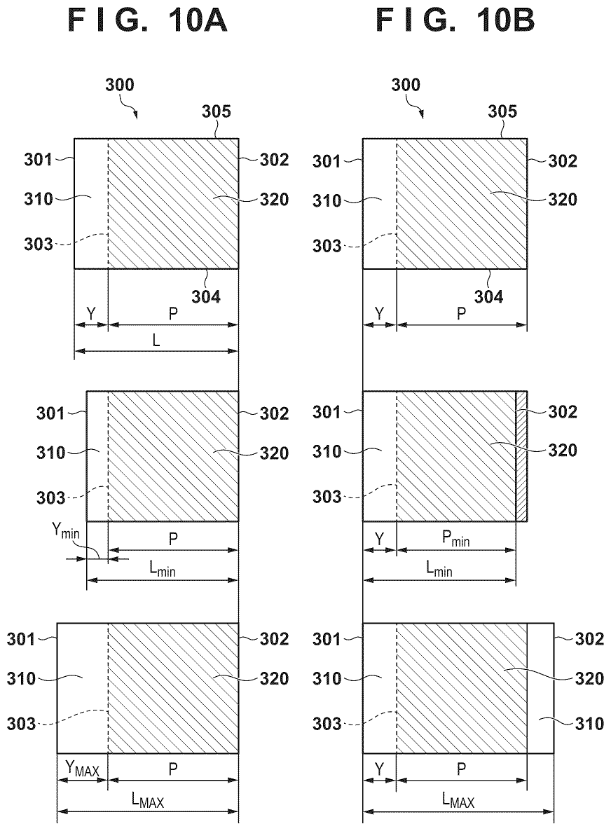

FIGS. 10A and 10B illustrate an example of a printed product printed by the printer 100 according to the present embodiment. As illustrated in FIGS. 10A and 10B, the printed product printed by the printer 100 has a blank margin 310 and a printing range 320. The blank margin 310 is a range in which printing is not possible, and is located on a leading end 301 side of the sheet. A length Y of the blank margin 310 corresponds to the distance between the conveyance roller 160 and the heating element 110-A of the thermal head 110. The printing can be performed such that there is no blank margin on three sides of the sheet, namely the following end 302, a side end 304, and a side end 305.

Processing for calculating the transfer start position, performed in step S114 of the printing operations described above, will be described next with reference to FIGS. 10A and 10B.

First, in response to the position of the following end 302 of the sheet being detected in step S113, the control unit 402 determines a position distanced by a length P of the printing range 320 as a transfer start position 303, based on the position of the following end 302 of the sheet. The effect of variation in a length L of the sheet 300 will be described next. Variation in the length L of the sheet 300 is high, at about 1.0 mm, due to variations in the manufacturing apparatus when the sheets are cut, but when the case where the sheet 300 has a length Lₘᵢₙ (i.e., is short), the blank margin 310 becomes shorter, at a length Yₘᵢₙ, as illustrated in FIG. 10A. However, the length P of the printing range 320 does not change. Also, when the sheet 300 has a length L_{MAX} (i.e., is long), the blank margin 310 becomes longer, at a length Y_{MAX}, but the length P of the printing range 320 does not change. In other words, the length of the printing range 320 can be fixed by detecting the position of the following end 302 of the sheet and determining the transfer start position 303 based on the position of the following end 302 of the sheet.

On the other hand, a method is also conceivable in which the position of the leading end 301 of the sheet is detected and a position distanced by the length Y of the blank margin 310 is determined as the transfer start position 303 based on the position of the leading end 301. In this case, as illustrated in FIG. 10B, when the sheet 300 is short, at a length Lₘᵢₙ, the length Y of the blank margin 310 does not change, and the printing range 320 becomes short, at a length Pₘᵢₙ, resulting in an area that cannot be printed (the finely-hatched part in the figure). When the sheet 300 is long, at the length L_{MAX}, the length Y of the blank margin 310 does not change, and the printing range 320 also remains at the length P. This results in a blank margin where nothing is printed on the following end 302 of the sheet.

In this manner, the position of the following end 302 of the sheet can be detected, and a position distanced by the length P of the printing range 320 can be determined as the transfer start position 303 based on the position of the following end 302 of the sheet. This makes it possible to appropriately prevent the occurrence of blank margins at the following end 302 of the sheet.

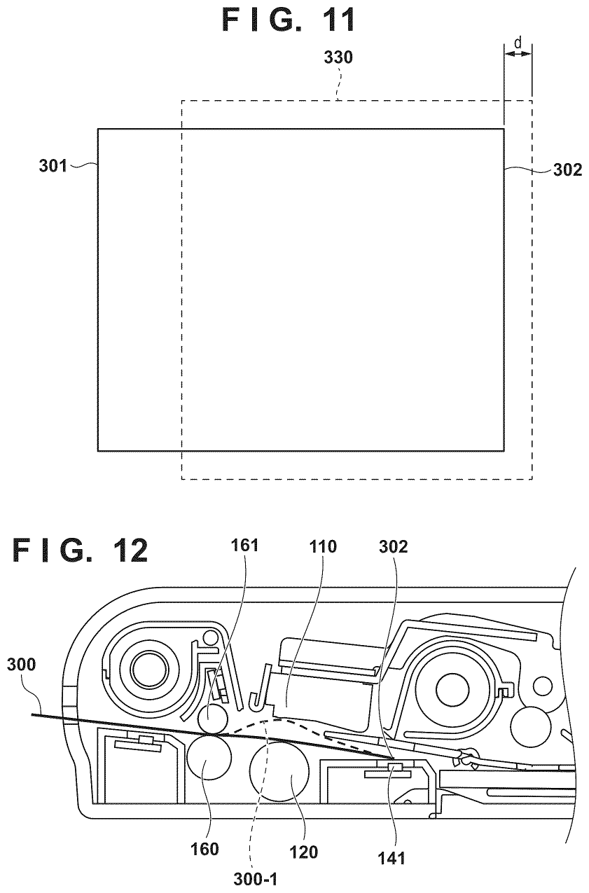

Processing for calculating the transfer end position, performed in step S118 of the printing operations described above, will be described next with reference to FIGS. 11 and 12. FIG. 11 illustrates a range 330 in which the heating element 110-A of the thermal head 110 is heated with respect to the sheet 300 according to the present embodiment. FIG. 12 illustrates the effect of bending in the sheet 300 according to the present embodiment.

Variation in the printing position is caused not only by the variation in the length of the sheet 300 as described above, but also by the variation caused by bending in the sheet 300. The transfer start position is determined in step S114 as described above. However, in step S114, the thermal head 110 is at the intermediate position, distanced from the platen roller 120, as illustrated in FIG. 12. As such, the sheet path is wide, and the sheet 300 may therefore bend to the position illustrated by the dotted line 300-1, as illustrated in FIG. 12. There is a difference of about 0.5 mm in the length of the sheet 300 from the following end 302 to the position nipped by the conveyance roller 160 and the driven roller 161, between the case where the sheet 300 is bent (the dotted line 300-1) and the case where the sheet 300 is straight rather than being bent. This difference in length results in variations in the printing position.

The printing position also varies by about 0.5 mm due to variations in the attachment position when the sheet feed port sensor 141 is attached to the printer 100, variations caused by the sensitivity of the sheet feed port sensor 141, and the like. Accordingly, to print without blank margins on the sheet 300, it is necessary to set the heating range 330 to be larger with respect to the sheet 300, as illustrated in FIG. 11. For example, it is necessary for the heating range 330 to be set at least 1.0 mm beyond the following end 302 of the sheet 300 (d in the figure).

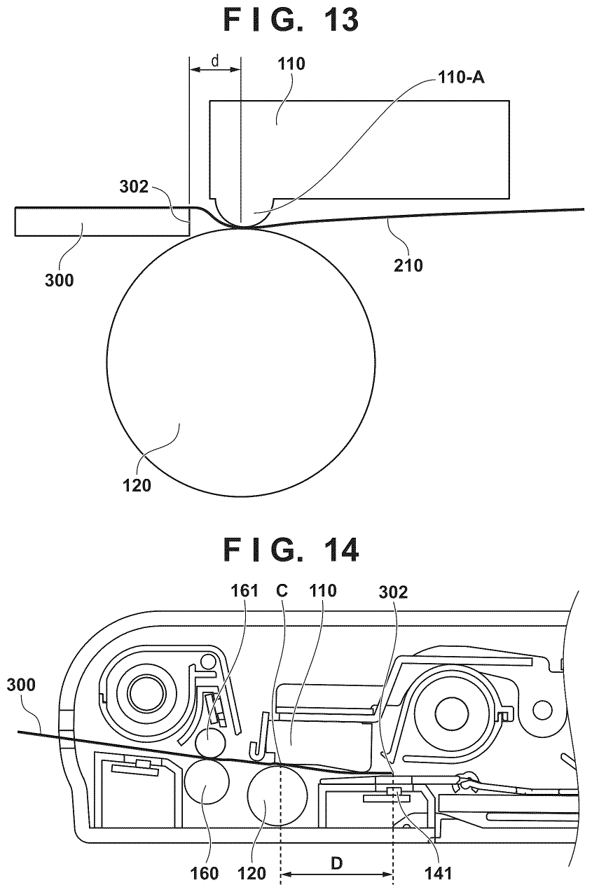

However, issues such as that described hereinafter may arise if the heating range 330 is set to be approximately 1.0 mm larger than the sheet 300. FIG. 13 schematically illustrates an issue arising when printing such that there is no blank margin at the following end 302, according to the present embodiment.

If the heating range 330 is larger than the sheet 300, printing is continued even after the following end 302 of the sheet 300 passes through the nip position between the thermal head 110 and the platen roller 120. As such, the heating element 110-A of the thermal head 110 emits heat in a state where only the ink ribbon 210 is nipped between the thermal head 110 and the platen roller 120, causing the dye on the ink ribbon 210 to be transferred to the platen roller 120. The back surface of the sheet 300 and the platen roller 120 are in constant contact during the printing operations thereafter, and thus the dye transferred onto the platen roller 120 may be transferred back onto the back surface of the sheet 300. For example, if, when the heating range 330 has been set to be at least approximately 0.5 mm larger than the sheet 300, dye is transferred to the platen roller 120, that transferred dye may be transferred back onto the back surface of the sheet 300.

In the range of approximately 0.5 mm near the following end 302, a gap between the platen roller 120 and the ink ribbon 210 is ensured by the thickness of the sheet 300. The dye on the ink ribbon 210 is therefore not transferred. However, the platen roller 120 and the ink ribbon 210 are in close contact with each other at positions further from the sheet 300, which means it is possible for dye on the ink ribbon 210 to be transferred.

The determination of the transfer end position in step S118 to suppress the transfer of dye to the platen roller 120 will be described next with reference to FIG. 14. FIG. 14 illustrates a state in which the following end 302 has been detected during printing operations by the printer 100 according to the present embodiment. As described earlier, when the transfer start position is determined in step S114, a variation of approximately 0.5 mm may arise due to bending of the sheet 300. Accordingly, when determining the transfer end position based on the position of the following end 302 of the sheet 300 detected in step S113, it is necessary to set the heating range 330 for the following end 302 to be at least 1.0 mm larger than the sheet 300, as described earlier.

However, at the timing when the position of the following end 302 is detected in step S117, the thermal head 110 is at the printing position, where the thermal head 110 is pressed against the platen roller 120, as illustrated in FIG. 14. In other words, the space through which the conveyed sheet can pass, formed between the thermal head 110 and the platen roller 120, is narrowed, which makes it difficult for the sheet 300 to bend. Accordingly, in step S118, the control unit 402 calculates the transfer end position based on the position of the following end 302 detected in step S117. Several methods can be used to determine the transfer end position based on the detected position of the following end 302. For example, by using a predetermined distance D indicating the distance from the sheet feed port sensor 141 to the position where the thermal head 110 is pressed against the platen roller 120, the transfer end position from a position C, where the transfer is currently being performed, can be obtained. Alternatively, the transfer end position from the transfer start position can be obtained by adding the predetermined distance D to the distance from the transfer start position to the position C. In other words, the transfer end position calculated in step S118 is closer to the following end of the recording sheet than the transfer end position determined based on the transfer start position (described above with reference to FIG. 11). Doing so makes it possible to reduce variations in the transfer end position to 0.5 mm or less. This in turn makes it possible to suppress the transfer of dye to the platen roller 120.

In the printing operations illustrated in FIGS. 9A and 9B, the following end 302 of the sheet 300 is detected during yellow printing, and the transfer end position is calculated during the yellow printing. However, if the printing speed is high, it is possible that the processing for calculating the transfer end position will not be performed in time. Accordingly, the transfer end position during the transfer of the first color among the plurality of dye colors (i.e., during yellow printing) may be calculated in advance from the transfer start position calculated in step S114, and the printing may then be performed. In this case, for the yellow printing, it is necessary to set the heating range 330 for the following end 302 to be at least 1.0 mm larger than the sheet 300. However, the transfer of dye back onto the back surface of the sheet 300, described above, can be reduced by lowering the density of the dye in the vicinity of the following end 302 before the transfer. In the magenta printing and cyan printing, the processing for calculating the transfer end position in step S118 is certain to already be complete, and thus the printing can be performed without reducing the density. In other words, in the yellow printing, the transfer end position is determined based on the transfer start position, and within a predetermined range from the transfer end position, the density of the dye is set to be lower than in areas outside that predetermined range. Then, in the magenta printing and cyan printing, the transfer end position can be determined to be a position different from the previously-determined transfer end position, based on the position of the following end detected during the transfer (in the yellow printing). Accordingly, the density of the dye is not reduced. Doing so makes it possible to minimize decreases in the darkness of the image to be printed, which in turn makes it possible to reduce the impact on the print quality.

Furthermore, in the present embodiment, among the plurality of colors of dyes, the yellow dye 251 is set as the dye to be transferred first. This is because compared to magenta and cyan, yellow has less influence on the printing darkness when the amount of dye to be transferred is reduced. In other words, setting the yellow dye 251 to be the first dye makes it possible to minimize the decrease in the darkness of the printed image mentioned above.

The present embodiment describes a case where dye is transferred to a sheet as an example. The dye is an example of ink, and the sheet is an example of a recording sheet. The present embodiment can therefore be applied when transferring ink onto a recording sheet.

In other words, according to the present embodiment, the printer 100 serving as an example of a printing apparatus detects a position of a recording sheet being conveyed, and controls transferring of ink and conveying of the recording sheet. A transfer start position of the ink is determined based on a detected position of a following end of the recording sheet being conveyed before the transferring of the ink starts. A transfer end position of the ink can be determined based on the detected position of the following end when a space through which the recording sheet being conveyed can pass is in a state arising while the ink is being transferred onto the recording sheet. By doing so, when transferring ink such that there is no blank margin at the following end of the recording sheet, the ink can be transferred accurately at the following end. The transfer of ink to the platen roller can also be suppressed by appropriately controlling the transfer in the vicinity of the following end of the recording sheet. In other words, it is possible to appropriately control transfer in the vicinity of the end of the recording sheet.

Note that the present embodiment is not limited to determining the transfer end position while transferring the ink onto the recording sheet. If the space through which the recording sheet being conveyed can pass is narrow, the transfer end position of the ink can be accurately determined based on the detected position of the following end. In other words, the transfer end position of the ink can be determined based on the position of the following end of the recording sheet being conveyed in a second state where the space through which the recording sheet being conveyed can pass is narrower than a predetermined first state. For example, due to the position of the thermal head before printing, illustrated in FIG. 6A, the space through which the recording sheet being conveyed can pass is in the first state. When the head drive motor moves the thermal head to a position lower than that illustrated in FIG. 6A, the space can enter the second state. In this manner, the transfer end position of the ink can be accurately determined, and the transfer can be appropriately controlled in the vicinity of the following end of the recording sheet.

In the embodiment described above, when the space through which the recording sheet being conveyed can pass is in the first state (a wide state), the transfer start position is determined based on the detected following end of the recording sheet. Then, the transfer end position is determined based on the position of the following end of the recording sheet detected when the space is in the second state (a narrow state). This makes it possible to determine the transfer end position with better accuracy than the transfer end position set based on the transfer start position (illustrated in FIG. 11).

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-204912, filed Dec. 4, 2023 which is hereby incorporated by reference herein in its entirety.

What is claimed is:

1. A printing apparatus comprising:
a detection unit configured to detect a position of a recording sheet being conveyed; and
a control unit configured to control transferring of ink and conveying of the recording sheet,
wherein the control unit:
determines a transfer start position of the ink based on a position, detected by the detection unit, of a following end of the recording sheet being conveyed before the transferring of the ink starts, and
determines a transfer end position of the ink based on a position, detected by the detection unit, of the following end of the recording sheet being conveyed in a second state where a space through which the recording sheet being conveyed can pass is narrower than a predetermined first state.

2. The printing apparatus according to claim 1, further comprising:
a recording unit configured to transfer the ink onto the recording sheet; and
a driving unit configured to move the recording unit such that the space through which the recording sheet being conveyed can pass is in the first state or the second state.

3. The printing apparatus according to claim 1,
wherein the first state is a state of the space before the transferring of the ink starts, and the second state is a state of the space during the transferring of the ink onto the recording sheet.

4. The printing apparatus according to claim 3,
wherein the first state is a state of the space when the following end is detected before the transferring of the ink starts, and the second state is a state of the space during the transferring of the ink onto the recording sheet.

5. The printing apparatus according to claim 2,
wherein the recording unit includes a thermal head, and
the first state is a state of the space when the thermal head is a predetermined distance from a roller for supporting the recording sheet, and the second state is a state of the space when the thermal head is closer to the roller than the predetermined distance.

6. The printing apparatus according to claim 1,
wherein the control unit determines the transfer start position in the first state.

7. The printing apparatus according to claim 1,
wherein the control unit determines the transfer end position based on the transfer start position determined, and then, based on the position of the following end detected in the second state, determines the transfer end position at a position different from the transfer end position determined.

8. The printing apparatus according to claim 7,
wherein the transfer end position determined based on the position of the following end is closer to the following end of the recording sheet than the transfer end position determined based on the transfer start position.

9. The printing apparatus according to claim 1,
wherein the ink is ink of one of a plurality of colors of ink, and
the control unit determines the transfer end position based on the position of the following end detected during the second state when a first ink is being transferred, the first ink being the ink, among the plurality of colors of ink, that is transferred first.

10. The printing apparatus according to claim 1,
wherein the ink is ink of one of a plurality of colors of ink, and
the control unit:
determines the transfer end position based on the transfer start position in a case where a first ink is to be transferred, the first ink being the ink, among the plurality of colors of ink, that is transferred first; and
determines the transfer end position based on the position of the following end detected before starting transfer of a second ink used after the first ink, in a case where the second ink is to be transferred.

11. The printing apparatus according to claim 10,
wherein in a case where the first ink is to be transferred, the control unit sets a density of the first ink to be lower in a predetermined range from the transfer end position determined based on the transfer start position, than in areas outside the predetermined range.

12. The printing apparatus according to claim 11,
wherein in a case where the second ink is to be transferred, the control unit skips reducing a density of the second ink.

13. The printing apparatus according to claim 10,
wherein the first ink has less influence on a printing darkness than the second ink in a case where an amount of ink transferred is reduced.

14. The printing apparatus according to claim 10,
wherein the color of the first ink is yellow.

15. The printing apparatus according to claim 1,
wherein the control unit determines the transfer end position at a position such that no blank margin is present at the following end of the recording sheet.

16. A control method of a printing apparatus including a detection unit configured to detect a position of a recording sheet being conveyed, the control method comprising:
controlling transferring of ink and conveying of the recording sheet,
wherein the controlling includes:
determining a transfer start position of the ink based on a position, detected by the detection unit, of a following end of the recording sheet being conveyed before the transferring of the ink starts, and
determining a transfer end position of the ink based on a position, detected by the detection unit, of the following end of the recording sheet being conveyed in a second state where a space through which the recording sheet being conveyed can pass is narrower than a predetermined first state.

17. A non-transitory computer-readable storage medium storing a program for causing a computer to execute a control method of a printing apparatus including a detection unit configured to detect a position of a recording sheet being conveyed, the control method comprising:
controlling transferring of ink and conveying of the recording sheet,
wherein the controlling includes:
determining a transfer start position of the ink based on a position, detected by the detection unit, of a following end of the recording sheet being conveyed before the transferring of the ink starts, and
determining a transfer end position of the ink based on a position, detected by the detection unit, of the following end of the recording sheet being conveyed in a second state where a space through which the recording sheet being conveyed can pass is narrower than a predetermined first state.
